(19) United States
(12) Patent Application Publication
(10) Pub. No.: US 2012/0010856 A1
(43) Pub. Date: Jan. 12, 2012

(54) WIRELESS DATA RETRIEVAL AND COLLECTION SYSTEM AND METHODS THEREFOR

(75) Inventors: Andrew G. Oliver, Niwot, CO (US); Alexander D. Brand, Westminster, CO (US); Victor L. Babbitt, Superior, CO (US)

(73) Assignee: Renewable Energy Systems Americas Inc., Broomfield, CO (US)

(21) Appl. No.: 12/834,200

(22) Filed: Jul. 12, 2010

(51) Int. Cl. G06F 15/00; G06F 17/40

(52) U.S. Cl. 702/187; 702/188

(57) ABSTRACT

A data retrieval and collection system is described. The system includes a plurality of measurement sensors, and at least one transmission unit associated with and interchangeably coupled to each of said measurements sensors. Each transmission unit includes an input for receiving measurement data from its respective sensor. The measurement data is received in a format specific for the respective sensor. An output communicates the measurement data. The system further includes an addressable base unit to be placed in communication with each transmission unit. The base unit automatically receives the measurement data from each transmission unit.

### BACKGROUND

Data collection plays a vital role in many industrial applications ranging from engine controls to environmental analysis. Depending on the application, data collection may be over a short interval or many years. One example of data logging occurring over a long period of time is in the oil and gas industry where quantities of captured oil and gas are continuously monitored in order to properly credit royalties and evaluate well production. Another example of long term data collection is environmental analysis where the ambient temperature in a particular geographic region is monitored over a period of years.

The collection of relevant data typically involves a sensor which communicates information to a data logger that compiles sensor data over a period of time. Many sensor types are prevalent in the art, including temperature, pressure, flow, and light intensity sensors, to name a few. In many applications locating the data logger near the sensor is impractical, especially where multiple sensors are spread over a large area. In applications where the sensor is located remotely from the data logger, an interface between the sensor and logger is necessary. For example, cables may be used to connect sensors to a logger. In some applications it may be impractical or dangerous to run cable between the location where the measurements are taken and the location where the data is recorded.

One particularly relevant example of where data logging is employed is a wind farm. Data logging can be important to wind turbine operation both in the planning stages of erecting a wind turbine as well as during operation. In the planning stages of wind turbine operation it is important to assess the available wind energy resources in a given location by measuring and logging information relevant to the design of the wind turbine tower heights, turbine selection, and tower spacing. For example, in a wind resource assessment the frequency, intensity, and predominant direction of wind in a particular location are of paramount importance to wind farm design and economics. Various types of anemometers may be used to measure the amount of wind that exists in a particular region.

In selecting the optimal height and spacing of wind turbines as well as the type of turbine employed it is important to take measurements of various parameters, such as for example, pressure, temperature, and wind speed over a suitable period of time and at a suitable frequency of collection. Also, it is desirable to take these measurements at a variety of altitudes in order to determine how the wind resource changes with height above ground. Accordingly, various spatially distributed sensors are employed to make such measurements. The meteorological towers that the sensors are mounted to typically range up to 300 feet in height. It is usually impractical to locate a data logger near each sensor not only because there are multiple sensors and data loggers are relatively expensive, but also because it is convenient to have the logger located near the ground so it can be easily interfaced to a broader network (e.g. via cellular or satellite modem). Accordingly, very long cables are typically used to connect the sensors to the data logger. One example of a system for use in conducting a wind resource assessment is the NRG-NOW System 60m XHD Calibrated SymphoniePLUS™ kit available from NRG Systems, Inc. of Hinesburg, Vt. (www.nrgsystems.com). This kit includes a tower, data logger, and an array of sensors. The sensors included in the kit include: 6 calibrated anemometers; 2 direction vanes; and a temperature sensor. The kit also includes the necessary enclosures, mounting booms, signal conditioners, and sensor cables. The cables in this particular kit range in length from 150 to 220 feet.

In the wind turbine application, in particular, it can be problematic to run cabling between the sensors and the logger. First, cables are rather expensive and when used in large quantities commensurate with a tall turbine tower the costs often become significant. Second, signal degradation over long distances of cable can occur thereby compromising data integrity. Also, because the sensors in this application are in place for a long period of time and extend to high altitudes, the cables may become susceptible to lightning strikes and become temporary lightning rods. These cables may also degrade over time causing signal errors, prompting for their replacement. Finally, it is labor intensive to run cables down a tower ensuring that they are fastened securely while maintaining a safe system of work.

One attempt to eliminate the cables used in previous systems is described in U.S. Pat. Nos. 7,591,176 and 7,454,968, both entitled Wind-Powered Wireless (RF) Anemometer. These patents describe a wireless anemometer that is powered by an AC generator that is turned by the anemometer's drag cups. The AC generator supplies the power necessary to communicate wind speed data to a receiver via a wireless network. While the anemometer described in these patents is convenient for remote wind speed sensing, it is not applicable for other remote measurements such as temperature, pressure, and wind direction.

Accordingly, there is a need not just in the wind turbine industry, but in many industries which use sensors and remote data loggers, for a more convenient and robust means of interfacing remote sensors with data logging equipment, thereby limiting the amount of cable extending between sensors and their associated data logger. Furthermore, a system is needed that can provide wireless remote sensing of not only wind speed but other parameters, such as: air quality, current, EM levels, events, flow, gas/pollutant, humidity, noise level, optical, precipitation, pressure, stress, temperature, voltage, vibration, and wind direction. Moreover, a generalized adaptor or remote sensor platform that allows the connection of widely differing remote sensors to a sensor network is desired.

### SUMMARY

Systems and methods are provided for retrieving and collecting data at a site. In a preferred embodiment, a data retrieval and collections system is provided for use in wind resource assessment at a site, although the ordinarily skilled artisan will recognize that there may be numerous other applications for the teachings herein. A plurality of measurement sensors are each mountable to a meteorological tower erected at the site. A remote unit is associated with and interchangeably coupled to each sensor. The unit includes an input for receiving measurement data from its respective sensor. The measurement data may be received by the remote unit in a format that is specific to the respective sensor. The remote unit may include an output configured to communicate the measurement data. The measurement data may be output from the remote unit to an addressable base unit. The base unit may be placed in communication with each remote unit. The base unit may be configured to automatically receive the measurement data from each remote unit. A data logging device may be coupled to the base unit for storing the measurement data.

In an exemplary embodiment, each remote unit includes an onboard, rechargeable power supply electrically coupled to a power harvesting device. These devices could include a solar panel, micro wind or the similar. Alternatively, the remote unit may be powered via a primary battery cell or other primary non-rechargeable device. The base unit and its associated remote unit(s) are configured to communicate wirelessly via radio frequency or optical medium. Any number of RF protocols could be employed including IEEE 802, spread spectrum, cellular or satellite. In a preferred embodiment the Zigbee protocol in accordance with the IEEE 802.15.4 standard is employed. To this end, each remote unit preferably includes a housing and a wireless communications module connected to the instrument housing. The measurement sensors may include any of the following: air quality, anemometer, barometer, current sensors, EM level detection, event counter, flow detection, gas/ pollutant detection, humidity, hygrometer, noise level, optical detectors, precipitation gauge, pressure, stress detectors, voltage sensor, vibration, wind vane or any other suitable sensor or device for use in a measurement campaign.

Each of the units is configured for field or remote programmable addressing. The address may be manually set by hardware or externally through interfaced software, which could be done by a direct connection (cable) or remotely via RF, cellular, PDA, PC or the like. In preferred arrangements, each remote unit includes one set of DIP switches that are set to a first unique address that identifies the respective remote unit, and a second set of DIP switches that are set to the unique address of the base unit. The base unit includes associated DIP switches for setting its unique address. Each remote unit is configured to receive and process different types of input data so that it is interchangeable with multiple sensor types. Examples of the different types of input signals the remote unit may receive may include, but is not limited to, analog, low level AC, pulse, 4-20 mA and serial which could include RS232, RS422, RS485, USB, or Ethernet. The base unit is configured to selectively output a plurality of different signal types such as, but not limited to, analog, low level AC, pulse, 4-20 mA and serial which could include RS232, RS422, RS485, USB, or Ethernet. Additionally the base unit could be configured for data streaming, internal storage (RAM) or external storage (data card), such that data received wirelessly from a remote unit is captured, and not reconverted to a specific output signal, but the data received from a remote unit is either processed programmatically to produce the result log data normally retrieved from a data logger, or is transferred from the base unit and processed off site. Each remote unit includes an associated micro controller and a switch coupled to the micro controller for selecting one of the data input types. Such switch may include automatic detection of the incoming signal, so that the operator need not manually set the switch. Alternatively, the input data type switch may be software configured by, for example, a configuration laptop. The base unit also includes at least one micro controller for processing measurement data received from each remote unit that it is paired with. In preferred arrangements, the base unit includes a master micro controller and a plurality of slave micro controllers that are each configured to process measurement data from a respective remote unit.

According to a data retrieval and collection methodology, a plurality of sensors are provided. In an exemplary embodiment the sensors are installed at respective locations on a device associated with a measurement system, such as a meteorological tower. A wireless transmission unit is coupled to an output of each sensor for transmitting measurement data. Each transmission unit is associated with a unique transmitter network address. A suitable recording device such as a data logger or PC is installed at a base region of the meteorological tower and coupled to a wireless receiving unit that is interfaced between each transmission unit and the data logger. Measurement data is received from each of the sensors and stored on the data logger for later retrieval. In another embodiment the data logger could be removed from the measurement site and the measurement data from the base unit could be sent via RF, cellular or the like to a remote recording device such as a data logger or PC in another location.

### BRIEF DESCRIPTION OF THE DRAWINGS

FIG. 1 is a system diagram illustrating an exemplary wireless data collection and retrieval system;

FIG. 2 is a schematic function diagram of a representative remote unit;

FIG. 3 is a schematic function diagram of a base unit;

FIG. 4 is a schematic diagram of the remote unit's battery terminal and main power switch;

FIG. 5 is a schematic diagram of the remote unit's charge management circuit;

FIG. 6A is a schematic diagram of the remote unit's 2.5 volt regulator;

FIG. 6B is a schematic diagram of the remote unit's 3.3 volt regulator;

FIG. 7 is a schematic diagram of the remote unit's voltage boost circuit;

FIG. 8 is a schematic diagram of the remote unit's micro controller unit (MCU);

FIG. 9 is a schematic diagram of the remote unit's zero cross detector circuit;

FIG. 10A is a schematic diagram of the remote unit base address DIP switch;

FIG. 10B is a schematic diagram of the remote unit's remote address DIP switch;

FIG. 11 is a schematic diagram of the remote unit's Xbee RF unit;

FIG. 12A is a schematic diagram of the remote unit's AC Schmitt trigger;

FIG. 12B is a schematic diagram of the remote unit's pulse Schmitt trigger;

FIG. 13 is a schematic diagram of the remote unit's parallel resistor for use with 4-20 mA sensor signals;

FIG. 14 is a schematic diagram of the remote unit's input signal select switch;

FIG. 15 is a schematic diagram of the remote unit's instrument input terminal;

FIG. 16 is a flow chart illustrating the remote unit's MCU data flow;

FIG. 17 is a schematic diagram of a representative base unit output signal terminal block;

FIG. 18 is a schematic diagram of the base unit's RS232 output;

FIG. 19 is a schematic diagram of the base unit's VDC input terminal;

FIG. 20A is a schematic diagram of the base unit 5 VDC regulator;

FIG. 20B is a schematic diagram of the base unit's 3.3 VDC regulator;

FIG. 20C is a schematic diagram of the base unit's 2.5 VDC regulator;

FIG. 21 is a schematic diagram of the base unit base DIP switch;

FIG. 22 is a schematic diagram of the base unit's RS-232 line driver/TTL to 232 converter;

FIG. 23 is a schematic diagram of the base unit's Xbee RF unit;

FIG. 24 is a schematic diagram of the base unit's master MCU;

FIG. 25 is a schematic diagram of the base unit's slave MCU and digital to analog converter;

FIG. 26 is a schematic diagram of the base unit's 4-position slide switch;

FIG. 27 is a schematic diagram of the base unit's level shifter;

FIG. 28 is a schematic diagram of the base unit's 8th order elliptic LPF switched capacitor;

FIG. 29 is a schematic diagram of the base unit's phase lock loop circuit;

FIG. 30 is a schematic diagram of the base unit's counter/divider;

FIG. 31 is a flow chart illustrating the base unit's master MCU data flow; and

FIG. 32 is a flow chart illustrating the base unit's slave MCU data flow.

### DETAILED DESCRIPTION

Described herein is a wireless data retrieval and collection system for providing a more convenient and robust means of interfacing remote sensors with conventional data logging equipment. The present systems and methods may be used to collect data for various types of applications. For example, the present systems and methods may be implemented to collect data related to, but not limited to, wind farm site assessment, weather station recordings, hydrographic recordings, oil and gas usage, environmental conditions, road traffic conditions, vehicle testing, or any suitable application where it is desirable to log data from one or more sensors.

In one configuration, the present systems and methods may limit the amount of cable extending between sensors and their associated data logger. Furthermore, the present systems and methods may provide wireless remote sensing of multiple parameters. For example, sensors used to capture data for wind turbine applications may capture parameter such as wind speed, temperature, wind direction, or pressure. In another example, sensors for a weather station may provide sensing of various parameters to the data logging equipment, such as wind speed, wind direction, temperature, relative humidity, solar radiation, and the like. Sensors used to capture hydrographic recordings may capture parameters such as water level, water depth, water flow, water pH, water conductivity, and the like. In one configuration, an adaptor for universally adapting various system sensors to a network is also provided.

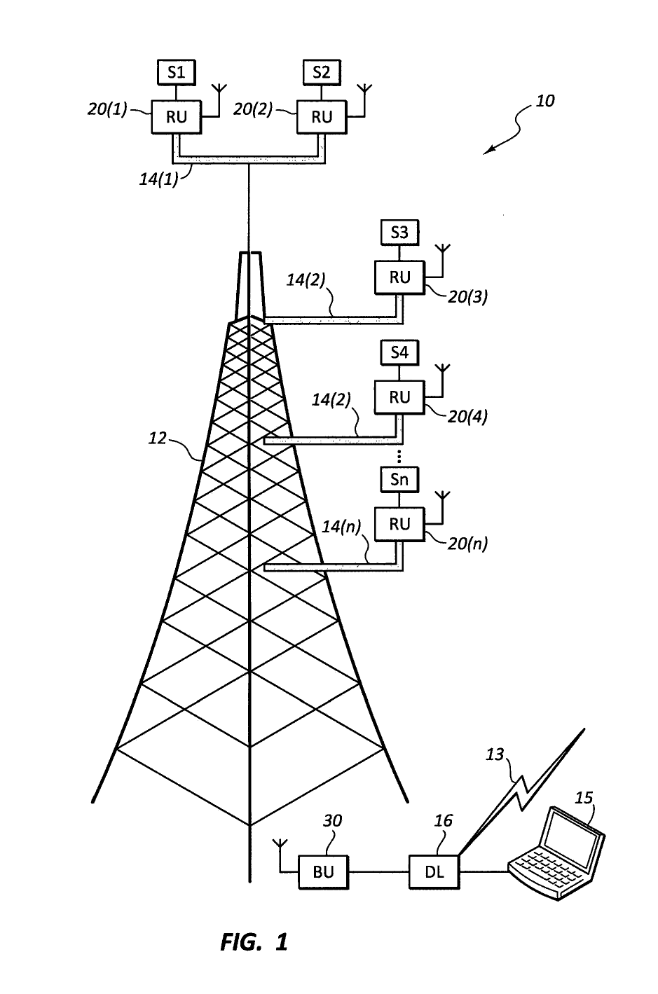

FIG. 1 illustrates a data collection system 10 for assessing the available environmental conditions in a given location. The system 10 may be used to collect data for various types of applications, such as the applications previously described. In one embodiment, the data collected by the system 10 may be used for the design and placement of one or more wind turbines. In one configuration, the system 10 may collect data by measuring and logging information relevant to the design of a wind turbine tower, turbine selection, tower spacing, and the like. While FIG. 1 illustrates a system to collect data relating to the design and placement of wind turbines, it is to be understood that the system 10 may also be used to collect data for multiple other applications, such as weather stations, hydrographic recordings, oil and gas usage, environmental conditions, road traffic conditions, vehicle testing, and any other application that logs data from one or more sensors.

In one example, the system 10 may include a mast 12 with a plurality of booms 14(1)-14(n). As shown, each boom supports a respective sensor S1-Sn, which is operative to sense certain conditions. For example, the sensors may sense various environmental conditions, such as, but not limited to, wind speed, temperature, pressure, wind direction, and the like.

Preferably, each sensor is connected to a universal remote unit 20(1)-20(n), respectively. In one embodiment, a remote unit may convert a signal from a sensor (i.e., sensor signal) to a certain format. For example, the remote unit may convert a sensor signal to a digital format. In one configuration, the converted sensor signal may be transmitted to a base unit 30. The base unit 30 may receive the converted data from the remote units 20(1)-20(n), and present the data in a format that is easily interfaced with conventional data logging equipment 16. The data may be transmitted 13 and/or downloaded via a device 15, such as, but not limited to, a portable computing device, a memory data storage device, or a mobile communications device.

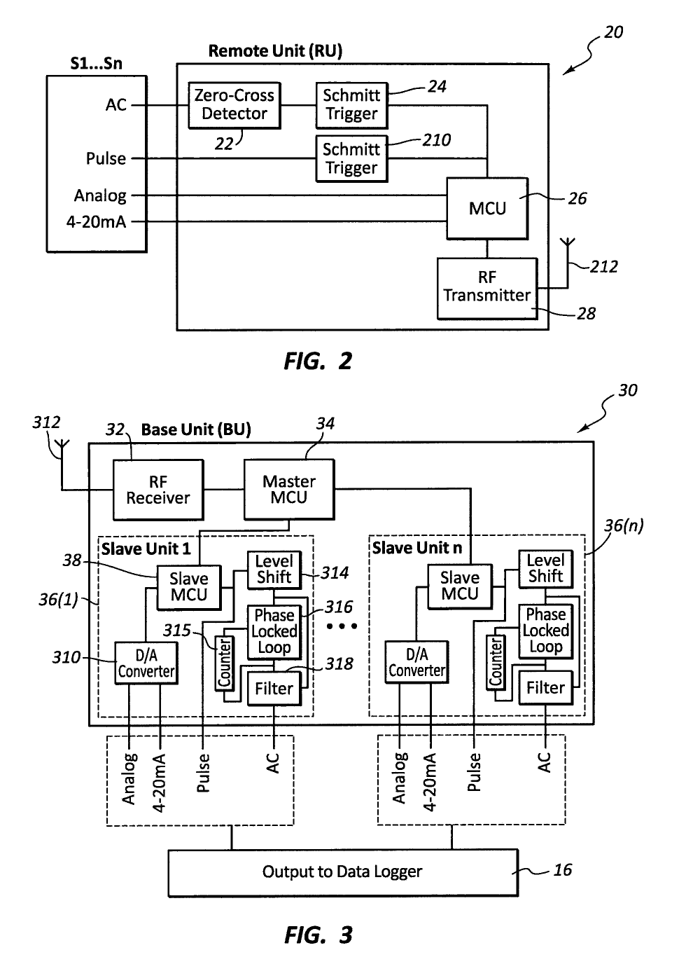

FIG. 2 is a block diagram illustrating one embodiment of a remote unit 20 that may receive a signal from a sensor, convert the signal into a format readable by a base unit 30, and transmit the converted signal to the base unit 30. In one embodiment, a sensor may be integrated as part of the remote unit 20. In another embodiment, a sensor may be separate and distinct from the remote unit 20. In this case, the sensor may be connected to the remote unit 20. The remote unit 20 may receive signals from multiple sensors. In another embodiment, the remote unit 20 may receive signals from a single sensor.

In one configuration, different sensors may transmit different types of signals to a remote unit such as, but not limited to, alternating current (AC) signals, pulse signals, analog signals (e.g., 4-20 mA), serial, SPI, I2C, and the like. In one embodiment, the remote unit 20 may be configurable to interface with multiple sensors. As a result, the remote unit 20 may be capable of converting several different types of sensor signals into a format readable by the base unit 30. In one example, the remote unit 20 may be capable of converting the various types of sensor signals into a digital format.

In one embodiment, an AC signal received by the remote unit 20 may be fed through a zero-cross detector 22 in order to detect for zero crossings of the AC signal. The output of the zero-cross detector 22 may then be fed into a comparator circuit, such as a Schmitt trigger 24. The output of the Schmitt trigger 24 may be fed into a microcontroller (MCU) 26. In one example, pulse signals may be fed to the Schmitt trigger 210 and then the output from the Schmitt trigger 210 may be input to the MCU 26. Analog signals (including 4-20 mA signals) may be fed directly to the MCU 26.

In one embodiment, the MCU 26 may include an analog-to-digital converter (ADC) such that signals inputted to the MCU 26 are converted into a digital format. The MCU 26 may package one or more converted signals and transmit the converted data to the base unit 30. To this end, a radio frequency (RF) transmitter 28 with an antenna 212 may be used to transmit the converted data to the base unit 30.

The base unit 30 illustrated in FIG. 3 receives the converted data from one or more remote units 20(1)-20(n). The base unit 30 may include an RF receiver 32 with an associated antenna 312. The receiver 32 may feed the converted data received from the one or more remote units 20(1)-20(n) to a master microcontroller unit (MCU) 34. The output of the MCU 34 may be input to one of several slave units 36(1)-36(n), depending on which remote unit the converted data was received from.

Output 16 of the base unit 30 is preferably transmitted to a data logger, a device often employed in wind farm site analysis. In one example, the data logger may be capable of interfacing with signal types originally generated by a sensor. As a result, each slave unit 36(1)-36(n) may convert the data back to the original signal type generated by a particular sensor. For example, a first sensor may generate an AC signal. The AC signal generated by the first sensor may be converted to a digital format for wireless transmission to the base unit 30, as previously explained. In order to interface the data collected by the first sensor to the data logger, the digital data may be converted back to the original signal type (e.g., an AC signal). The AC signal may then be transmitted to the data logger.

In one configuration, slave units 36(1)-36(n) may have similar construction and perform similar operations. As a result, the description of one slave unit is applicable to other slave units. A slave unit 36 may include a slave MCU 38 that receives digital data from the master MCU 34. If the original signal type is an analog signal, slave MCU 38 may send the data to an analog-to-digital converter (ADC) 310. The ADC 310 may output an analog signal, such as a 4-20 mA signal.

In another embodiment, if the original signal type is a pulse signal, the slave MCU 38 may handle the conversion directly with an on board pulse width modulator that outputs the digital data as a square wave. If the original signal type is an AC signal, the digital data may be fed to a level shift circuit 314 that may raise the output level to approximately 5 volts. The signal is preferably then fed through a phase locked loop 316 and filter 318 to convert the signal to a sine wave output (i.e., an AC signal).

In preferred embodiment, the base unit 30 may not include various slave MCUs. However, it is also contemplated that the master MCU 34 alone could be employed to convert the various signals received from the remote units 20(1)-20(n) back to the their original signal types. In any event, as each signal received from a remote unit is converted back to the original signal type The signals may then be transmitted to and received by the data logger 16. Having generally described the overall operation of the system, the circuitry and data flow of the remote units and base unit are described in more detail below.

### Remote Unit Operation

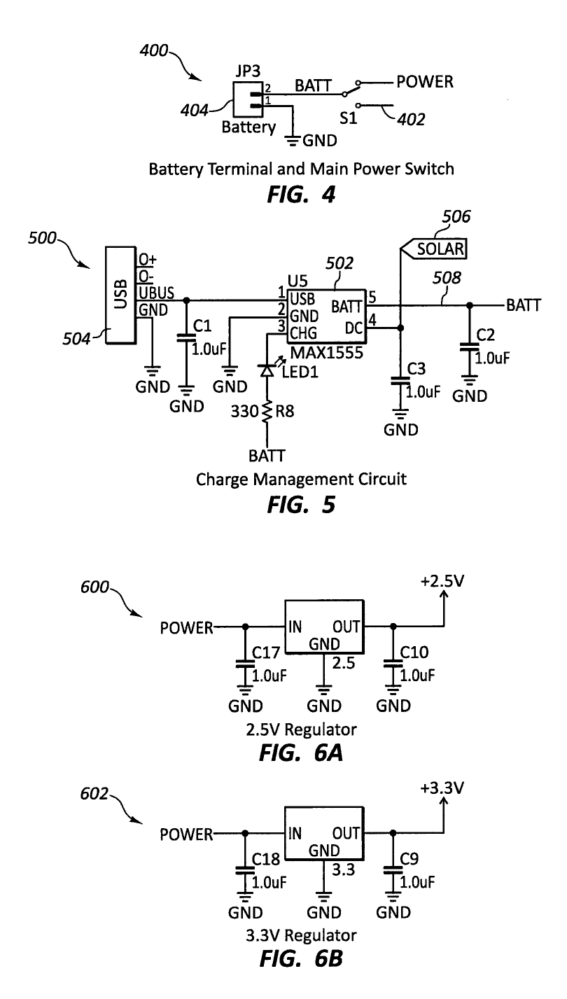

The remote unit's power management components are shown in FIGS. 4-7. In one configuration, the power management components may be housed in a self-contained unit of a selected size and configuration. The power management unit may be a part of, or a separate module from, the remote unit.

With reference to FIG. 4, a power switch Si 402 may turn power on and off to the power management unit. The management unit may include a battery 404. In one embodiment, the battery 404 is rechargeable, such as a JP3 lithium polymer battery. The battery 404, however, may be of any other type of battery that is capable of providing power to a remote unit. In one example, the battery 404 may hold an energy charge of approximately 1100 to 1200 milliampere hours (mAhrs) and provide a voltage of approximately 3.3 volts (V).

A charge management circuit 500, shown in FIG. 5, may include a battery charging circuit 502. In one example, the charging circuit 502 employs a MAX1555 chip available. The charging circuit 502 may be powered from various sources. For example, the charging circuit 502 may use universal serial bus (USB) power 504. In another example, the charging circuit 502 may be powered from a solar source 506. In one embodiment, the charging circuit 502 may be powered from any sort of direct current (DC) voltage supply.

The charge management circuit 500 may attempt to maintain about 4.2 volts direct current (VDC). In one embodiment, the circuit 500 may disconnect from the battery 508 if less than about 3.2 VDC is produced. The voltage may run through a voltage regulator. If the voltage level is below the voltage specified for the regulator, there is a possibility that the proper voltage level may be affected, which may affect voltage high or low determinations in a transistor-transistor logic (TTL) that may be present in the circuitry of the remote unit. Utilizing a microcontroller with brown out protection can alleviate against this.

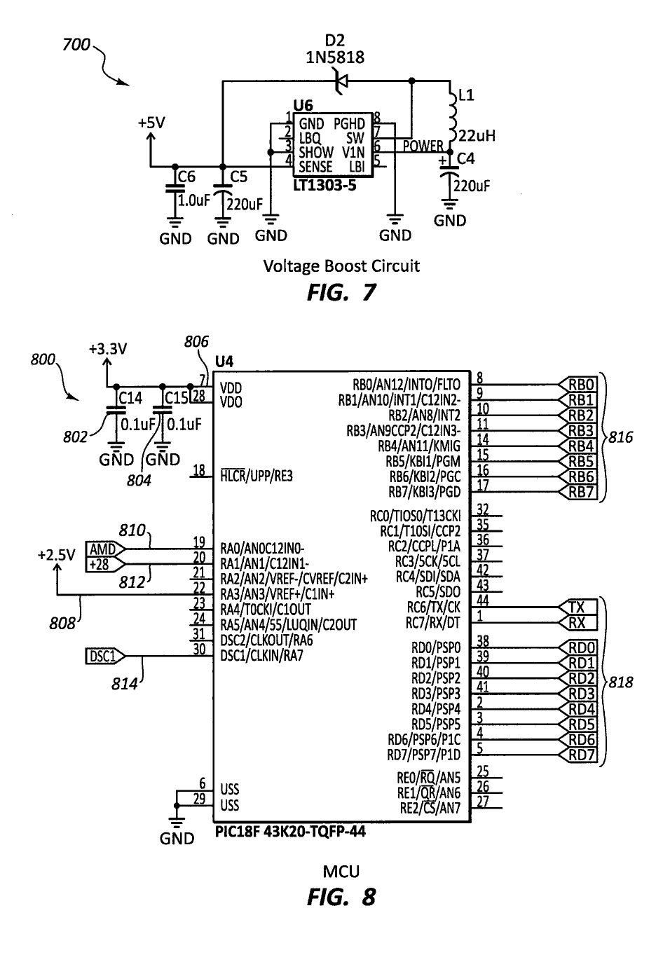

FIG. 6A illustrates one embodiment of a voltage regulator 600. In one example, the regulator 600 may be a 2.5 V regulator for maintaining the voltage used during the digital to analog conversions of the sensor signals described above. FIG. 6B illustrates another embodiment of a voltage regulator 602, here a 3.3 V regulator for supply a certain voltage (e.g., 3.3 V) to various integrated circuit (IC) chips included in the power management unit. FIG. 7 illustrates one embodiment of a voltage boost circuit 700. When the remote unit is connected to the power management unit, the voltage boost circuit 700 allow the remote unit to supply a certain voltage to devices or instruments that may be connected to the remote unit. In one example, the boost circuit allows the remote unit to supply 5V to any instrument or device that is connected to the remote unit.

FIG. 8 illustrates one embodiment of a microcontroller (MCU) 800 that may be in the remote unit. Various types of MCUs may be used. As an example, a PIC 18F series MCU may be used for the MCU 800. In one configuration, the MCU 800 may include one or more filtering capacitors 802, 804 for filtering a power supply rail provided by a power supply unit (e.g., the power management unit). Voltage provided on the power supply rail may be received at a power supply pin 806 of the MCU 800. A reference voltage 808 may also be provided to the MCU 800. In a preferred embodiment this reference voltage 808 is in the range of approximately 0 to 2.5 V.

The MCU 800 may also include an analog input 810 to receive analog signals and a 4-20 mA input 812 to receive 4-20 mA signals. In addition, the MCU 800 may also include an oscillator input 814 to receive an external oscillator signal from a pulse AC signal that may be applied from an external instrument (such as a sensor). As previously explained, the MCU 800 may convert the various analog signals, 4-20 mA signals, and AC signals to digital form. In one embodiment, the MCU 800 may include an internal oscillator running at a clock rate of 8 megahertz (MHz). Alternatively, an external crystal oscillator could be employed. The MCU 800 may include a first port 816 that includes various pins that for identifying an external device with which it is paired, such as the base unit. The MCU 800 may also include a second port 818 with various pins for use identifying the remote unit itself.

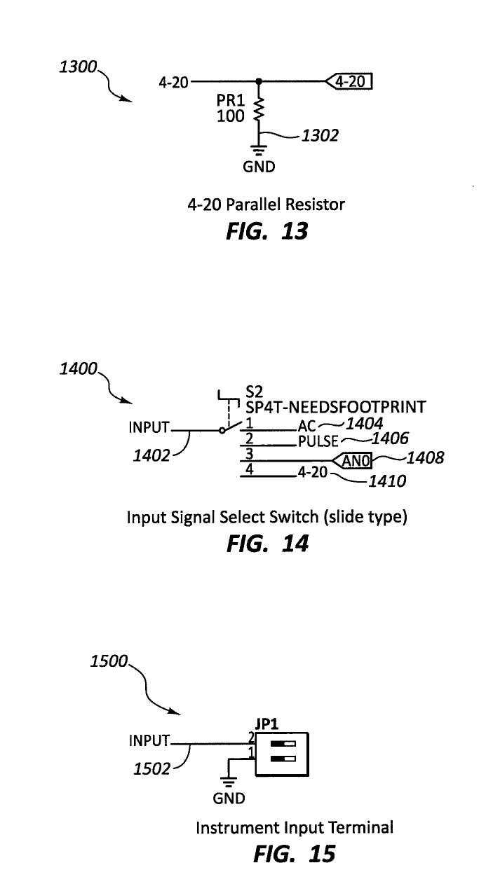

An input signal select switch S2 1402, shown in FIG. 14, may allow the remote unit to be configured to receive various input types 1404, 1406, 1408, 1410. Each instrument/sensor input may be connected to the remote unit via an instrument input terminal 1502 such as shown in FIG. 15. The remote unit may be configurable to receive numerous types of input signals, such as, but not limited to, analog, 4-20 mA, pulse, AC signals, serial and the like. On the MCU 800, pins 19 and 20 (810, 812) may receive analog sensor inputs. Pin 20 (812) may receive a 4-20 mA signal. In one embodiment, the 4-20 mA signal may be first converted from current to a voltage range. As a result, a parallel resistor 1302 may be included in the circuit (see FIG. 13). In one embodiment, the parallel resistor 1302 may provide a voltage range under 2.5 V for the 4-20 mA signal.

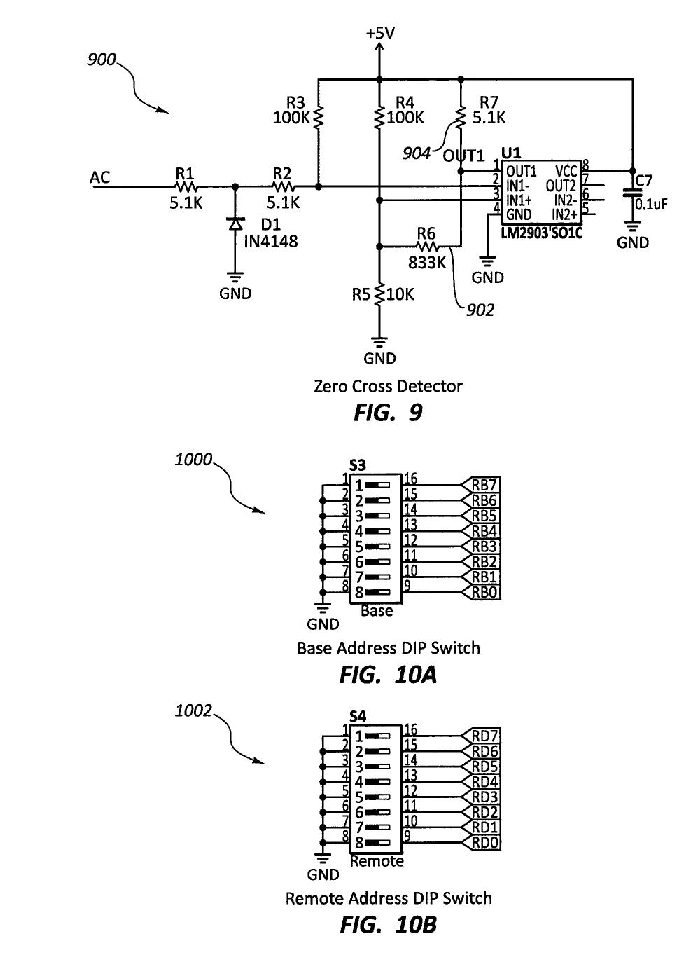

Pin 30 (814) of the MCU 800 may receive an external oscillator signal from sensors that provide a pulse or AC signal. AC signals may be input to a zero-cross detection circuit 900 shown in FIG. 9. In order to be received by the MCU 800, an AC signal is converted to a square wave (i.e., a digital format). In one embodiment, the zero-crossing circuit 900 may convert a sine wave (such as an AC signal) into a square wave. A feedback circuit 902 may be designed to have a 60 millivolt (mV) hysteresis (noise threshold). Each time the AC signal drops below zero a comparator will invert the logic signal. A resistor (R7) 904 pulls the signal up to 5 volts when it is to go high.

The output from the zero-cross detector circuit 900 is fed into an AC Schmitt trigger circuit 1200 (see FIG. 12A). In one configuration, the AC Schmitt trigger circuit 1200 may clean up the square wave signal and reduce noise on the signal. Pulse signals may be fed directly from a sensor into a Pulse Schmitt trigger 1202 (see FIG. 12B) in order to reduce noise on the pulse signal. The AC signal or pulse signals are then be fed from their respective Schmitt triggers 1200, 1202 to pin 30 (814) on the MCU 800.

As previously explained, a 2.5 volt reference may be supplied to pin 22 (808) on the MCU 800 from the 2.5 volt regulator. The MCU 800 may use the reference voltage on pin 22 (808) to perform the analog to digital conversions. In one configuration, the MCU 800 may have 10 bit resolution (i.e., 1024 voltage steps). As a result, the MCU 800 may convert the analog signal on pin 19 (810) to a digital signal somewhere between, as an example, 0 and 2.5 volts.

Referring to FIGS. 10A and 10B, dual in-line package (DIP) switches may be used to assign the addresses for the base and remote units. A base address DIP switch 1000 may determine which base unit the remote unit will communicate with. A remote address DIP switch 1002 may be used to assign a unique address for each remote unit. Each DIP switch 1000, 1002 may include 8 pins providing 256 possible addresses. The base and remote address DIP switches 1000, 1002 may be connected to the first port 816 that includes various pins and the second port 818 that includes various pins, respectively. The switches on the DIP switches 1000, 1002 may be rotary, slide, rocker, and the like.

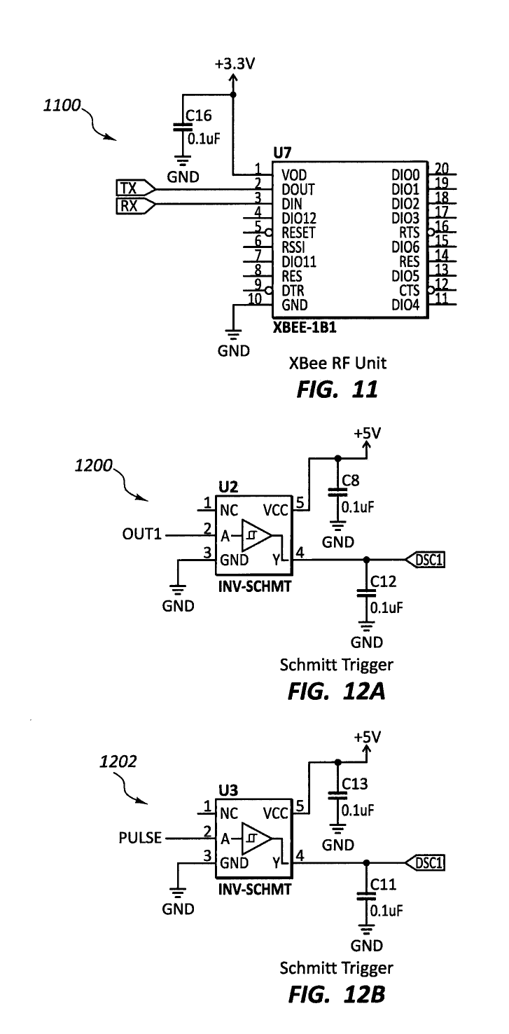

In one embodiment, the RF transmitter 28 may include an RF transmitter circuit 1100 (see FIG. 11). The transmitter circuit 1100 may transmit data according to a certain protocol, such as the ZigBee protocol. However, it is contemplated that the data may be transmitted according to other protocols (e.g., Bluetooth) or according to other specifications (e.g., WirelessHART) if desired.

The remote unit 20 may include a wire antenna which connects to the transmitter 28 or a reverse polarized subminiature version A (SMA) cable that connects to a small wave antenna (plugs into the transmitter 28). In one embodiment, the transmitter 28 may be configured to run in application programming interface (API) mode to allow access to a set of acceptable commands that can be sent to the transmitter 28. If desired, data transmitted from the RF transmitter 28 may be encrypted.

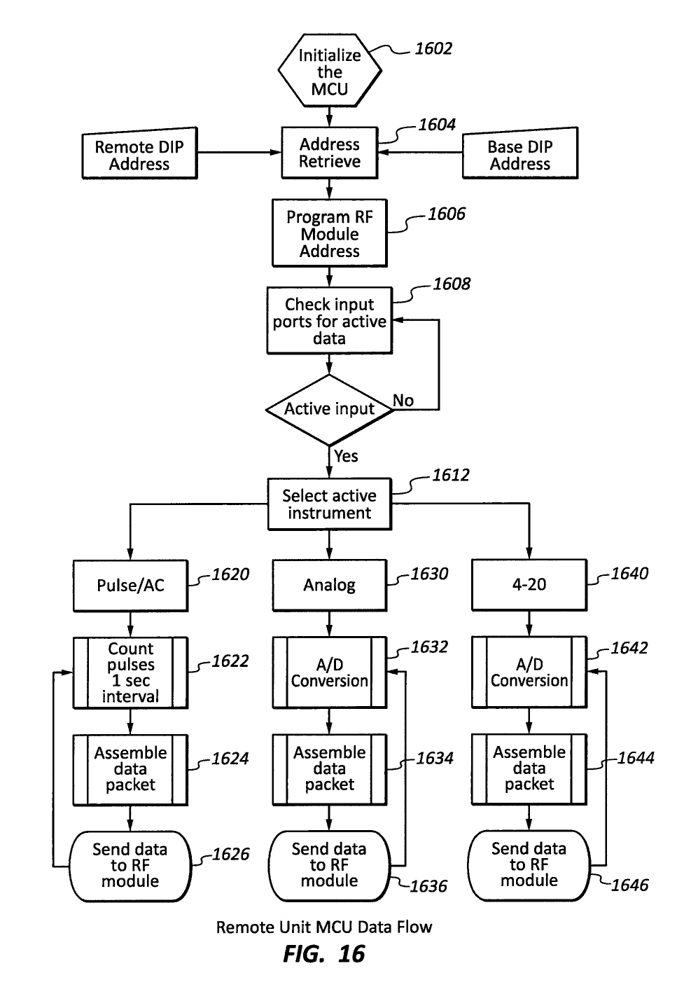

FIG. 16 illustrates one embodiment of the data flow for the remote unit MCU 800. At 1602 the MCU 800 is initialized and configured when the remote unit is powered up. During initialization an internal oscillator may be configured. In one embodiment, the internal oscillator is configured, it is configured to reset when the remote unit is powered up. In addition, a watchdog timer may be initialized. In one embodiment, the watchdog timer will reset the remote unit if there is an error in the code, or some operation is not completed in a selected amount of time. Initialization of the MCU 800 may also disable the master clear. At 1604 the MCU 800 retrieves the address values from the base and remote DIP switches 1000, 1002, and at 1606 the MCU configures the transmitter circuit 1100, including providing the base and remote unit addresses.

Once the unit is initialized and configured it begins checking the input ports for active data at 1608. As explained above, the input ports correspond to pins 19 (analog), 20 (4-20), and 30 (pulse or AC). Depending on which type of input is connected to the remote unit, the unit performs the appropriate data acquisition process.

In one embodiment, if the remote unit is connected to a sensor that provides a pulse signal or AC signal 1620, the external clock may count every time there is a rising edge on the signal, which generates at 1622 a hexadecimal number corresponding to a frequency that represents how many pulses were recorded during that interval (e.g., each second). A data packet is then assembled at step 1624. In a preferred configuration the data packet is serial data that is sent (each second) to the transmitter 28, and includes how many bytes are being sent. Within these bytes is the information of how many pulses were recorded in each second and which instrument it was from. A checksum may be provided to decrease the possibility of incurring errors. The data packet is sent to the RF module at 1626, which then transmits to the base unit. The base unit translates the pulses per second from an anemometer, for example, into wind speed. Each instrument comes with its own transfer function that is applied to convert the frequency signal from anemometer into wind speed.

If the remote unit is connected to a sensor that outputs analog or 4-20 signals 1630 and 1640, respectively, the signal is fed into an A/D converter which is internal to the microcontroller. Once the A/D conversion (1632/1642) is complete a data package is assembled (1634/1644) and sent to the RF module (1636/1646) for communication to the base unit.

### Base Unit Operation

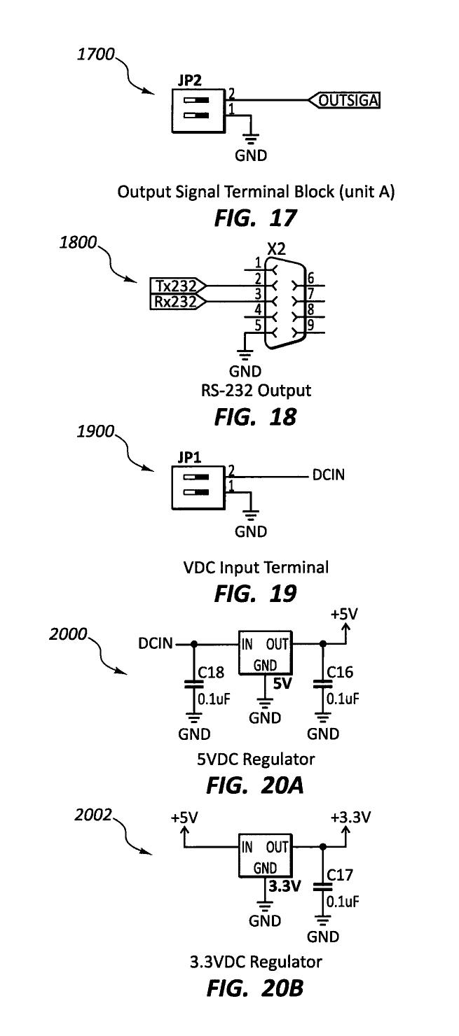

The base unit may include several output terminals. FIG. 17 illustrates one example of an output terminal 1700 of the base unit. The output terminal 1700 may output a signal to the data logger. The data logger may store the information received from one or more base units. The base unit and data logger may be connected via a wired connection. For example, the base unit may include an RS-232 connection 1800 shown in FIG. 18. The connection 1800 may feed out real time data to the data logger or a computer, for example. The base unit and data logger may be connected via other types of connections. For example, the base unit and data logger may be connected via an RS-422 connection, an RS-423 connection, an RS-449 connection, an RS-485 connection USB, Ethernet, and the like.

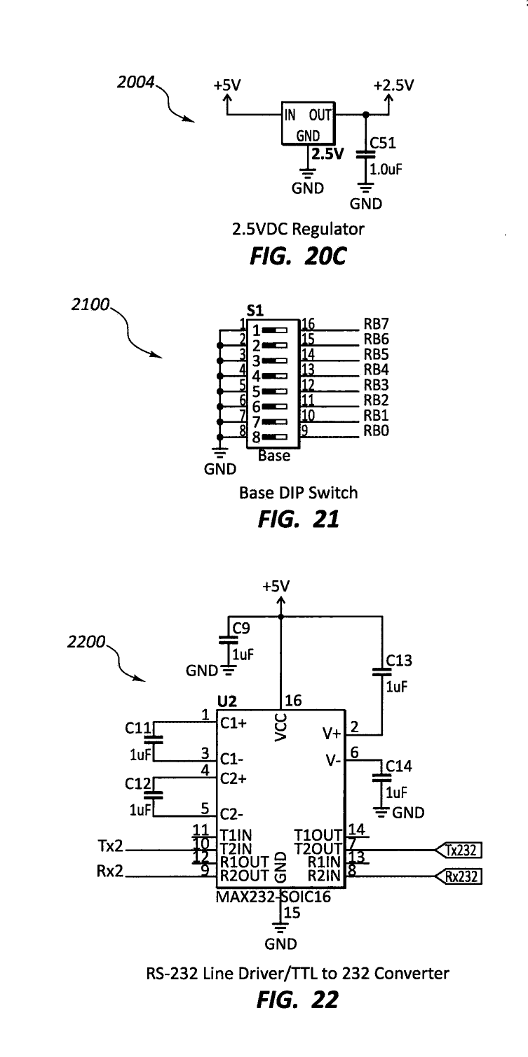

External power may be provided to the base unit via a VDC input terminal 1900 shown in FIG. 19. The external power supply 1900 may also be used to power the data logger. One or more voltage regulators may be used to step down the DC voltage from the power supply 1900. A 5 VDC regulator 2000 (FIG. 20A), a 3.3 VDC regulator 2002 (FIG. 20B) and a 2.5 VDC regulator 2004 (FIG. 20C) may be provided to regulate the power supplied to the base unit. The 2.5 VDC regulator 2004 may be a precision voltage regulator that supplies the reference voltage for the digital to analog conversion. The base unit address may be programmed with a base DIP switch 2100 shown in FIG. 21 that connects to a first port of pins 2416 on a master MCU 2400, illustrated in FIG. 24.

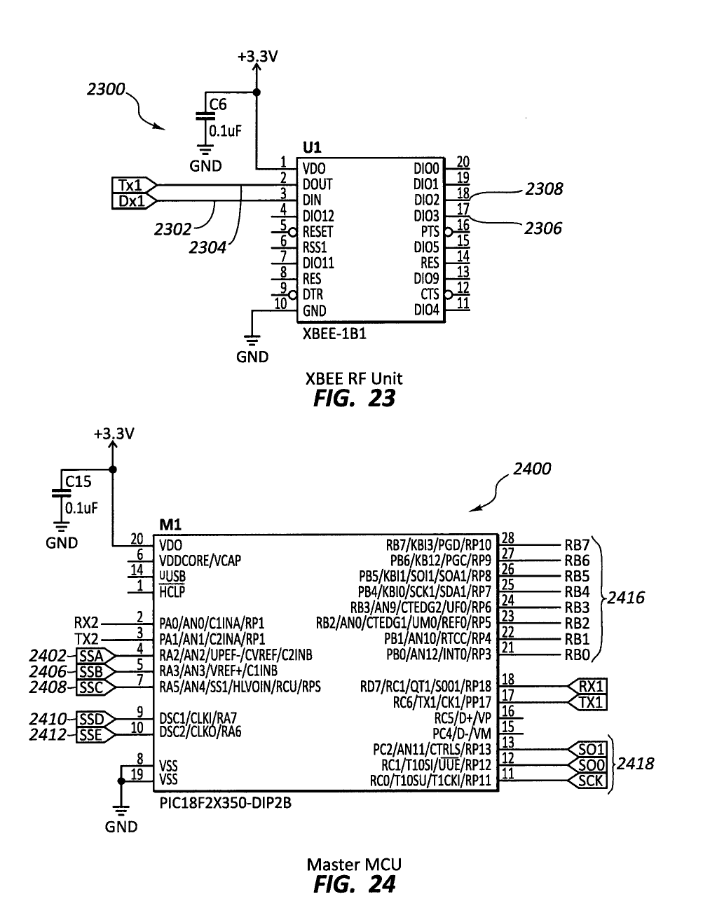

FIG. 23 illustrates one embodiment of an RF receiver circuit 2300 that may be included in the RF receiver unit 32. In one configuration, the RF receiver circuit 2300 may be a XBEE RF circuit 2300 that receives data from the remote unit 20 via a RF receiving pin 2302, and transmits the data via a RF transmitting pin 2304. The data may be transmitted to an MCU receiving line 2306 and an MCU transmitting line 2308. The master MCU 2400 may output the data to a line transceiver 2200 which converts the data into a format readable between the base unit and the data logger, such as in accordance with an RS-232 connection standard.

In one configuration, the line transceiver 2200 shown in FIG. 22 may use a MAX 232 IC that takes the voltage levels of the circuitry 2200 (i.e., the TTL voltage level) and converts those voltage levels to a format that may be readable by a computing device. For example, the voltage levels may be converted according to complementary metal-oxide semiconductor (CMOS) technology.

In addition to outputting data in a format that is in accordance with the connection between the base unit and the data logger, the base unit may also convert the digital data received from each remote unit back to its original format. For example, the digital data may be converted back to an analog signal, a 4-20 mA signal, a pulse signal, an AC signal, or any other type of signal that originated from a sensor. The digital data may be converted back to its original format so that it may be input to the data logger.

In one embodiment, a plurality of slave MCUs are connected to the master MCU 240. Each slave MCU may handle the data conversion for the data received from one of the remote units. With reference to FIG. 24, pins 4 (2402), 5 (2404), 7 (2406), 9 (2408), and 10 (2410) may be chip select lines that corresponding to a slave MCU. Lines 11-13 (2418) may provide the serial data in and out of the master MCU 2400. In addition, lines 11-13 (2418) may provide a clock reference. In one embodiment, the master MCU 2400 may implement a standard protocol serial peripheral interface (SPI).

In one configuration, data may come in from the RF receiver circuit 2300 and the master MCU 2400 reads the address of the remote unit that transmitted the data. Each remote unit's address may be within a certain range of addresses (e.g., 30 units). As a result, data coming in from a remote unit addressed in a first range may be directed to a first output circuit (slave MCU). When the remote unit address is in the second range, the data may go to a second output circuit, and so on. This arrangement also has the advantage of limiting the number of units that can be attached, thus preventing saturation of the bandwidth. In one example, the base and remote units may use an 8-bit address. As a result, there may be 256 available addresses for the base units and remote units. Dividing the 256 available addresses by the number of remote units connected to the system may provide the range for each unit's address.

As previously explained, included in the data coming into the master MCU 2400 from the RF receiver 2300 is the address of the remote unit which originally sent the data. The address associated with the data may indicate which of the various SPI lines on the MCU 2400 go high, which in turn may determine which slave microcontroller is activated to read the data. The data may be passed to each slave microcontroller, but the data may only be read in by the selected slave microcontroller. The slave microcontrollers may be run off different clock rates from each other and from the master MCU 2400. The slave microcontrollers may be aware, however, of the clock rate the data is being sent so that the data is read in correctly. Accordingly, along with the serial data provided from the master MCU lines SD0 and SD1, a clock reference may be provided at line SCK. In one embodiment, the inactive slave microcontrollers may be placed in low power sleep mode until they are activated by a high signal from the master MCU 2400. In one embodiment, the base unit may not use slave MCUs.

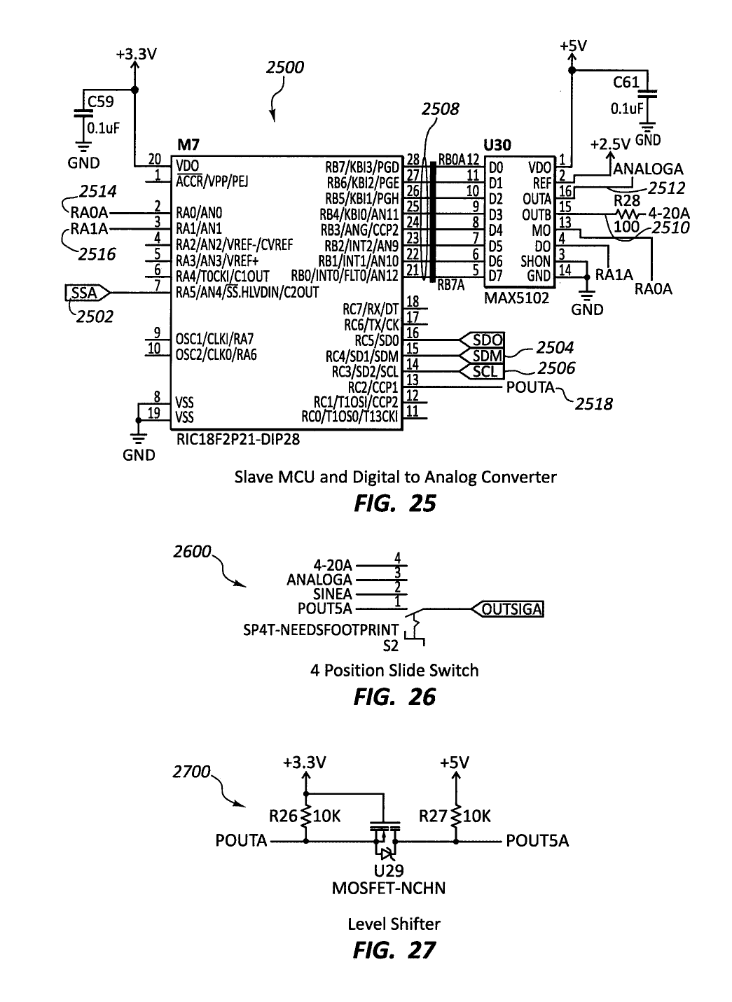

In one embodiment, each slave unit may include an 8 bit microcontroller 2500 that uses the SPI interface, such as shown in FIG. 25. The master MCU 2400 may activate the slave microcontroller 2500 by driving a select line SSA 2502 high (pin 7). Serial data may be read in through line SDI 2504 (pin 15) and clock reference may be fed into line SCK 2506 (pin 14). The type of data that is output from the slave MCU 2500 may be determined by a 4-position slide switch S2 2600, shown in FIG. 26.

Each slave MCU may have an associated digital to analog converter (DAC) for converting the digital data back to analog data. The master MCU 2400 may send data as bytes (hex values), which may then be written out to the DAC from the slave MCU on lines 21-28 (2508) as a binary value. The DAC may perform the conversion and output an analog signal on either line OUTA OR OUTB (pins 15 or 16) 2510, 2512 depending on whether the original signal was an analog signal or a 4-20 mA signal. The slave MCU 2500 may select the type of output the DAC will output through lines RA0A and RA1A 2514, 2516. A series resistance is used of the same value he used and he's using the same reference voltage as before to convert it back consistently. Preferably the resistor is a precision resistor (e.g. 1%).

Line POUTA (pin 13) 2518 may be used to handle the conversion of digital data to an AC signal or a pulse signal. Data may come in as a digital value and then the data may be output as a pulse width modulated (PWM) signal. A PWM converter may be built into the slave MCU 2500 chip. The signal output from POUTA 2518 may be a 50% duty cycle square wave corresponding to the frequency of the digital value.

In one embodiment, the PWM signal may be fed to both a square wave pulse output and other circuitry to convert the square wave into a sine wave AC output. The signal coming from POUTA 2518 may be a 3.5 volt pulse. This signal is preferably fed to a level shifter 2700 (see FIG. 27). The level shifter pulls the signal up to 5V if the signal is 3.3V. In addition, the level shifter 2700 pulls down the signal to 0 volts if the signal is less than 3.3V. The signal that originally came from the instrument may be a 5 volt logic signal. A 5V square wave may then be filtered into a sine wave for AC output. As a result, the square wave may be filtered to remove harmonics (2^{nd}-4^{th}) that created the square wave. The range may be approximately DC zero to 10 kHz.

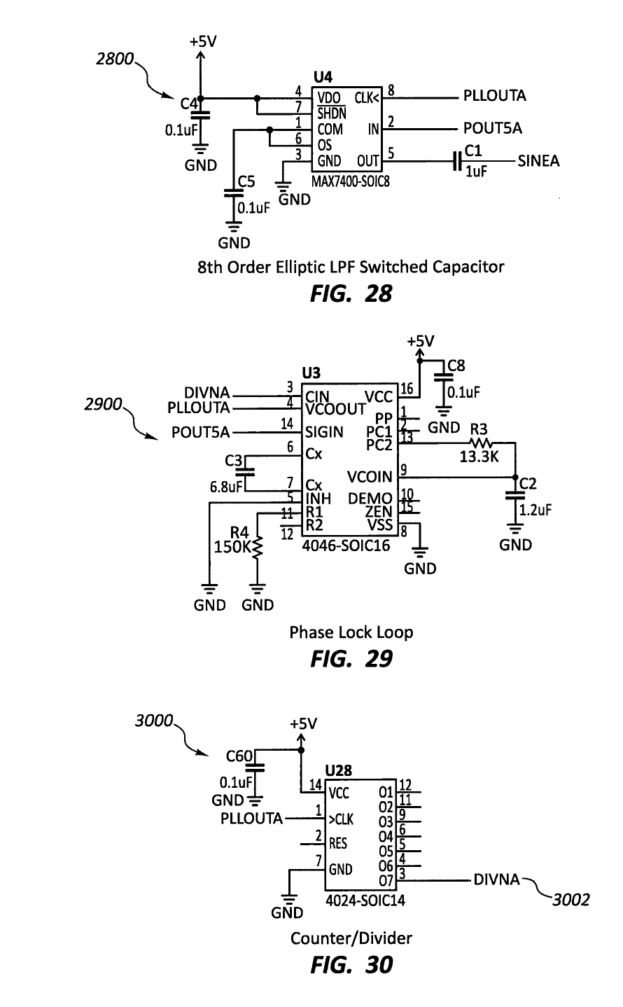

The signal may be fed into a phase locked loop (PLL) 2900 (see FIG. 29). The frequency of the incoming signal may be multiplied by a certain value and fed it into a high order (8^{th} order) sharp roll off low pass filter 2800 (see FIG. 28) as a frequency controlled clock. The frequency cutoff may be 1/100^{th} of the clock input. As an example, the input frequency may be multiplied by 128 and feed to the clock input. As a result, the corresponding filter cutoff will be 1/128^{th} of the clock, or the frequency of the input signal. In one example, a MAX7400 IC may be used for the filter 2800. The MAX7400 IC may be a switch capacitor filter whose capacitors can change value so the cutoff frequency can shift. In one example, all of the harmonics are cut off resulting in a smoothed out square wave. The output of the Phase Locked Loop 2900 may be fed back to itself through a binary counter 3000 (see FIG. 30) back to a DIVNA line 3002 (pin 3). The PLL 2800 may output the difference between the output and DIVNA, which may become the new output signal. However, every time the signal comes back around the signal may be divided by 128 so that the PLL 2800 may increase its speed by a factor of 128.

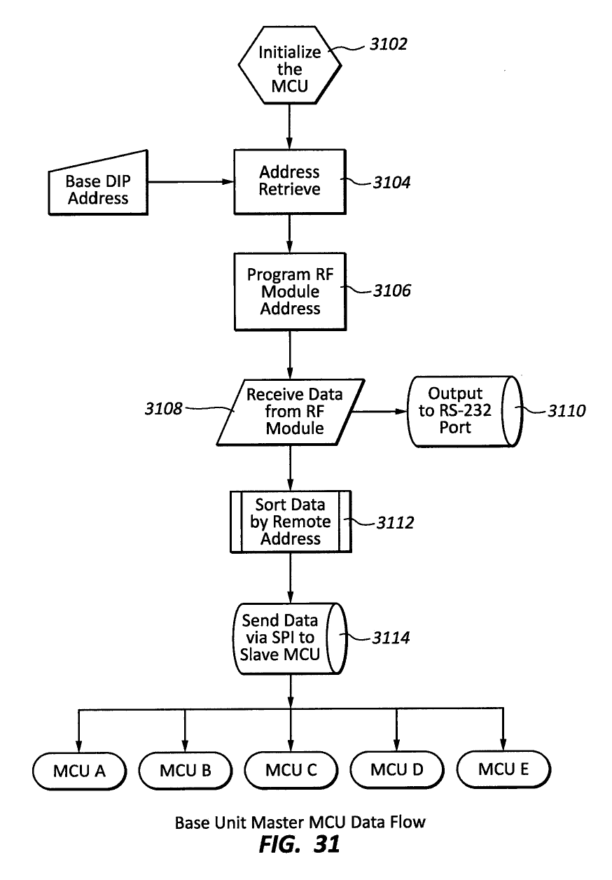

FIG. 31 illustrates the base unit master MCU data flow. At step 3102 the MCU is initialized. The MCU is initialized on startup to configure the microcontroller similar to that described above with respect to the remote units. At step 3104 the MCU retrieves the address value from the base DIP switch. At step 3106 the MCU configures the XBEE RF unit, including providing the base unit address.

Once the unit is initialized and configured, the master MCU begins checking for data. As data is received at 3108 it may be output to the RS-232 port at 3110. The data is also sorted by remote address and fed to slave units for further processing at 3112. In a preferred embodiment the data is sent at 3114 to the slave units via a serial peripheral interface (SPI), although other protocols such as I2C could be used.

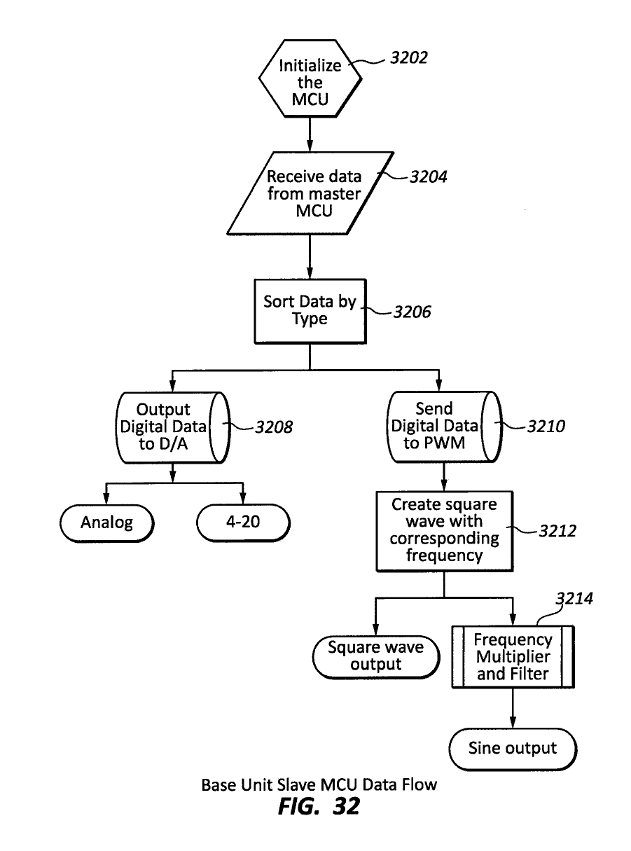

FIG. 32 illustrates a base unit slave MCU data flow. At step 3202 the MCU is initialized. The MCU is initialized on startup to configure the microcontroller similar to that described above with respect to the remote units. At 3204 data is received from the master MCU. At 3206 the data is sorted by type (i.e. Analog, 4-20, pulse, or AC). Analog data is sent to the DAC at 3208 to be output as either analog or 4-20 data. Pulse and AC data are sent at 3210 to the internal pulse width modulator to be output initially as a square wave (step 3212). At this point the signal may be output as a pulse signal or further processed into a sine wave AC output. Sine wave output may be filtered at 3214. Once converted from digital data to the various output types, a data logger may record the information.

Accordingly, the wireless data retrieval and collection system has been described with some degree of particularity directed to the exemplary embodiment. It should be appreciated, though, that the present system is defined by the following claims construed in light of the prior art so that modifications or changes may be made to the exemplary embodiments without departing from the concepts contained herein.

What is claimed is:

1. A data retrieval and collection system, comprising:
a plurality of measurement sensors;
at least one transmission unit associated with and interchangeably coupled to each of said measurements sensors, each transmission unit including an input for receiving measurement data from its respective sensor, wherein the measurement data is received in a format specific for the respective sensor, and an output configured to communicate the measurement data; and
an addressable base unit configured to be placed in communication with each transmission unit, wherein the base unit is configured to automatically receive the measurement data from each transmission unit.

2. A data retrieval and collection system according to claim 1 including a recording device coupled to said base unit for storing said measurement data.

3. A data retrieval and collection system according to claim 1 wherein said plurality of measurement sensors includes at least one measurement sensor of a first type and at least one measurement sensor of a second type different than the first type.

4. A data retrieval and collection system according to claim 1 wherein said measurements sensors are selected from a group consisting of air quality, anemometer, barometer, current sensors, EM level detection, event counter, flow detection, gas/pollutant detection, humidity, hygrometer, noise level, optical detectors, precipitation gauge, pressure, stress detectors, voltage sensor, vibration, wind vane.

5. A data retrieval and collection system according to claim 1 wherein each transmission unit includes an onboard, rechargeable power supply.

6. A data retrieval and collection system according to claim 5 wherein each transmission unit includes a solar panel for use in recharging said power supply.

7. A data retrieval and collection system according to claim 5 wherein said power supply of each transmission unit is recharged through wind.

8. A data retrieval and collection system according to claim 1 wherein said base unit and each transmission unit is configured to communicate wirelessly.

9. A data retrieval and collection system according to claim 1 wherein said base unit and each transmission unit is configured to communicate through wired communications.

10. A data retrieval and collection system according to claim 1 wherein each transmission unit includes a wireless communications module.

11. A data retrieval and collection system according to claim 1 wherein said base unit and each transmission unit are configured for field or remote programmable addressing.

12. A data retrieval and collection system according to claim 1 wherein said base unit is configured to selectively output a plurality of different signal types.

13. A data retrieval and collection system according to claim 12 wherein said signal types include analog, low level AC, pulse, serial, USB, Ethernet and 4-20 mA output signaling.

14. A data retrieval and collection system according to claim 1 wherein each transmission unit is configured to receive and process different types of input data from different types of sensors.

15. A data retrieval and collection system according to claim 14 wherein each transmission unit includes an associated microcontroller and a switch coupled to said microcontroller for selecting one of said data input types for processing by the microcontroller.

16. A data retrieval and collection system according to claim 2 wherein said base unit includes at least one microcontroller for processing measurement data received from each transmission unit that is paired with said base unit, and at least one base unit switch for selecting one of said data types to output to said recording device.

17. A data retrieval and collection system according to claim 16 wherein said base unit includes a master microcontroller, a plurality of slave microcontrollers each configured to process measurement data from a respective said transmission unit, and a switch associated with each slave microcontroller for selecting one of said data types from a paired one of said sensors.

18. A data retrieval and collection system according to claim 1 wherein said base unit is configured to store locally the measurement data received from at least one transmission unit.

19. A data retrieval and collection system according to claim 2 wherein said base unit is configured to convert the format of the measurement data into a format specific for the recording device according to the respective sensor.

20. A data retrieval and collection system according to claim 1 wherein said base unit is configured to automatically detect at least one transmission unit and the format of the measurement data received from one or more sensors in order to locally store the measurement data on said base unit.

21. A data retrieval and collection system according to claim 2 wherein said base unit is configured to automatically detect at least one transmission unit and the format of the measurement data received from one or more sensors in order to convert the format of the measurement data into a format specific for the recording device.

22. A data retrieval and collection system according to claim 2 wherein said base unit is configured to convert the measurement data into a format specific for the recording device and store the converted measurement data locally on said base unit.

23. A data retrieval and collection method for use in site assessment, comprising:
providing a plurality of sensors;
coupling an associated transmission unit to an output of each sensor, said transmission unit configured to transmit measurement data received from its associated sensor, wherein the measurement data is received in a format specific for the associated sensor;
associating a unique transmitter network address to each said transmission unit;
coupling a receiving unit to a recording device so that said receiving unit is interfaced for communication between each transmission unit and said recording device; and
automatically receiving measurement data from each said transmission unit.

24. A data retrieval and collection method according to claim 23 further comprising converting said measurement data to a format specific for said recording device.

25. A data retrieval and collection method according to claim 24 further comprising storing said measurement data on said recording device for later retrieval.

26. A data retrieval and collection method according to claim 23 further comprising installing said sensors on a meteorological tower, each at a respective sensor location.

27. A data retrieval and collection method according to claim 26 wherein said recording device is a data logger, and comprising installing said data logger at a base region of the meteorological tower.

28. A data retrieval and collection method according to claim 23 further comprising interchangeably coupling at least one of said transmission units between a plurality of said sensors.

29. A data retrieval and collection system for wind resource assessment at a site, comprising:
a plurality of measurement sensors each mountable to a meteorological tower erected at the site;
a remote unit associated with and interchangeably coupled to each of said measurements sensors, each remote unit including an input for receiving measurement data from its respective sensor, wherein the measurement data is received in a format specific for the respective sensor, and an output configured to communicate the measurement data;
an addressable base unit configured to be placed in communication with each remote unit, wherein the base unit is configured to automatically receive the measurement data from each remote unit, wherein the base unit is further configured to convert the measurement data to a format specific for a data logger; and
the data logger coupled to said base unit for receiving and storing said measurement data.
